(19) United States
(12) Patent Application Publication
(10) Pub. No.: US 2006/0106930 A1
(43) Pub. Date: May 18, 2006

(54) Method of querying for device location in a heterogeneous network

(76) Inventor: James D. Shaffer, Rancho Santa Fe, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/281,952

(22) Filed: Nov. 15, 2005

Related U.S. Application Data
(60) Provisional application No. 60/628,114, filed on Nov. 17, 2004.

(51) Int. Cl. G06F 15/173

(52) U.S. Cl. 709/224

(57) ABSTRACT

The present invention includes a method and system for providing network location information for real-time location-based services for parties communicating over networks from multiple carriers. Once a first party initiates a transaction over a public network, such as a telephone call (PSTN, cellular, VoIP) or a wireless Internet/Web transaction, the system obtains an identifier associated with a first party device during communication over a network. The system determines a network type and a network identifier from a plurality of potential network types and network identifiers based on the obtained first party identifier. The system selects a device location provider based on the network type and the network identifier and obtains location information from the selected device location provider based on the obtained identifier. The system provides the location information for use in a variety of location-based services.

### RELATED APPLICATION

This application claims the benefit of U.S. provisional patent application 60/628,114, entitled METHOD OF QUERYING FOR DEVICE LOCATION IN A HETEROGENEOUS NETWORK, filed on Nov. 17, 2004, which is incorporated herein by reference in its entirety.

### 1. FIELD OF THE INVENTION

The present invention relates to obtaining device locations in a heterogeneous network. Additionally, it relates to methods that determine a source from which to obtain location information based on identifier of a network device and then retrieve the location information for use in location-based services.

### SUMMARY

There are benefits to methods for providing location information for use in location-based services that can accommodate multiple device types communicating in a heterogeneous network environment with multiple network providers.

According to one embodiment, a system for providing network location information for real-time location-based service providers for parties communicating over networks from multiple carriers is provided. The system comprises a communication service provider system (hereafter called “service provider”), which can determine a location of the device, such as a mobile device, stationary or other, and can provide location-based services.

In order to determine the location of the device, the service provider can itself find the location, or, alternatively, it can request and receive the location information from another device location provider, such as, for example, a wireless device location provider, wire-line device location provider, location provider for VoIP users, or other. Similarly, in order to provide location based services, the service provider can itself supply the services, or alternatively, it can pass the request to another location-based services provider.

In one embodiment, first, the service provider obtains the device identifier, which can be, for example, an Automatic Network Identification (“ANI”) or IP address. After acquiring the device identifier, the service provider determines the type of the device, the type of network and network identifier. Then, the service provider uses that information to select a device location provider, which obtains location information for the device. The device location provider provides the location information by retrieving that information from own database, or by querying other location providers, such as, for example, Mobile Positioning Centers (“MPC”), secondary providers via gateways, location providers for VoIP users, etc. Other location providers such as location providers for VoIP users can obtain the location information from own database, or, alternatively, they can obtain that information from, e.g., mobile devices network.

According to another embodiment, a method of providing network location information for real-time location-based service providers for parties communicating over networks from multiple carriers is provided. The method comprises acquiring a device identifier during communication over a heterogeneous network, and then, determining both the type of the network and the network identifier. These device attributes are used to select a phone service provider that can supply location information for the device from the device location provider. The location information is then obtained and provided for use by a location-based service provider.

Location information can be obtained for a variety of devices. Each device is recognized by a device identifier. Examples of device identifiers can include a 10-digit phone ANI of a telephone call and an IP address of the device.

Device identifiers can be obtained in various ways. For example, a device identifier can be provided automatically by the network or provided by the device itself.

There is a variety of communication networks. A network can be wire-line or wireless. There are also Internet Protocol (“IP”) networks, such as, VoIP and wireless Internet. Examples of network access providers can include the Operating Companies (“OC”), Internet Service Provider (“ISP”) and Internet Access Provider (“IAP”). The type of network can be determined using the ENUM protocol.

Selecting a device location provider for the device can include selecting a first service for a wire-line network type and a second service for a wireless network type. In some embodiments, location information can be obtained by indexing a database with a telephone number. If the device is a wireless device such as a mobile phone, then obtaining location information can include querying a service that provides location information obtained from the wireless network infrastructure, such as from a MPC. If the device has a GPS receiver, then location information can be provided from the device. The location information can include altitude.

In some embodiments a request for location information can include routing a location information request to one of a plurality of device location providers. Among other things, this can provide for increased reliability through redundancy. Obtaining location information can include obtaining location information of or from a network access point of a device, sending a query over a network to obtain a location of a telephone number or an IP address, or sending a query to obtain a location provided from the device.

Some embodiments include connecting the device to a second party or directing the first party to a second party based on the location information, or selling or offering to sell a product based on the location information.

According to another embodiment, a method of providing location information for mobile and stationary communication devices for use by a location-based service provider presented. First, a device identifier associated with a first party device during communication over a network is obtained. Then, based on the obtained identifier, default network identification from a first database is obtained. Then, a determination is made as to whether the default network identification is valid or invalid based on a third party data source. If the default network identification is invalid, then, based on the obtained identifier, replacement-network identification is obtained from a second database.

Based on the network identification, a determination can be made as to whether the first party device is a mobile device or a stationary device. If the first party device is a stationary device, the first party device location can be obtained from a stationary device location provider. Alternatively, if the first party device is a mobile device, the first party device location can be obtained from a mobile device location provider.

In various embodiments, the default network is determined to be either a wire-line or wireless network. The default network identification can include identifying the default network based on a subset of the obtained identifiers, such as the area code and exchange of a telephone number. Determining whether the default network identification is valid or invalid can include retrieving information on identifiers that have been ported between wire-line and wireless networks.

In yet another embodiment, a method of providing network location information for real-time location-based services for mobile and stationary communication devices is provided. First, a service provider obtains an identifier associated with a first party device during communication over a network. Then, based on the obtained first party identifier, the service provider determines whether the first party device is a mobile device or a stationary device. If the first party device is determined to be a mobile device, then a network provider is identified based on the obtained identifier and location information is obtained from a mobile device location provider based on the network provider and the obtained identifier. If the first party device is determined to be a stationary device, then location information is obtained from a stationary device location provider based on the obtained identifier. The device location information can be useful to, for example, a variety of location-based services.

In some embodiments determining whether the first party device is a mobile device or a stationary device includes identifying a default device type of mobile or stationary from a first database based on the obtained first party identifier and determining whether to use the default device type based on information from a second database based on the obtained first party identifier.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a high level block diagram illustrating an example of the network relationship between mobile and stationary devices connected over a public network to phone-line service providers and a device location information server;

FIG. 2 is a high level block diagram illustrating an example of interfaces to wire-line and wireless location providers, and a communication service provider; and

FIG. 3 is a flowchart illustrating an exemplary process for the determination of the source of location information during communication with a wire-line or wireless device.

### DETAILED DESCRIPTION

Certain embodiments as disclosed herein provide for making available the location information for use in location-based services that can accommodate multiple device types (mobile and/or stationary) communicating in a heterogeneous network environment with multiple network providers. For example, one method as disclosed herein allows for providing network location information for real-time location-based services for parties communicating over networks from multiple carriers.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

Historically, when there was really only one global public telephone network, the PSTN (Public Switched Telephone Network), and almost all telephones were stationary nodes, and there were very few telephone operating companies (OC), it was fairly simple to identify the approximate location of any node in the network by using all or part of the telephone number (which constituted the telephone's network node identification (“id”)).

U.S. Pat. No. 4,191,860 to Weber used the first 3 digits (often referred to either as the NPA or the area code) of this network node id to determine the general geographic location in the North American Numbering Plan where this phone was located. U.S. Pat. No. 4,757,267 to Riskin improved on the geographic precision using the first 6 digits (often referred to either as the NPA-NXX or the area code and exchange) of the phone number along with the corresponding V-H coordinates (a derivative of latitude and longitude provided by Bellcore, now Telcordia) to determine the location of the physical network switch to which the phone was connected. Later, U.S. Pat. No. 5,506,897 to Moore, et al. used the full 10-digit phone number passed as the network ANI or provided by the caller via voice or Dual Tone Multi-Frequency (“DTMF”) to determine a more precise location of the network node.

Moore disclosed examples of 10-digit telephone number databases with terminating address information residing inside the regulated telephone network in conjunction with a Spatial Key to determine a precise spatial location of the network id. This Spatial Key could be passed outside the regulated portion of the network to the public portion of the network for various telephone routing type applications. Moore's preferred Spatial Key, the USPS ZIP+4 code, could be translated into a latitude and longitude using public and commercially available information from companies such as GDT (Geographic Data Technology) to obtain a location of the calling node that 95% of the time was accurate to plus or minus 105 feet.

Since the development of this early telephone network art, however, there have been significant regulatory and technology changes in both the number and the types of networks that greatly impact the complexity of determining the current location of a network node like a telephone identified by its network address. The telephone network has evolved from a predominantly homogeneous network (the original Plain Old Telephone Service (“POTS”) network) to become a more heterogeneous network including various mobile networks based on multiple protocols (e.g., PCS, GSM, CMDA, and TDMA) as well as other networks such as Internet telephony that can use other protocols such as Voice over Internet Protocol (VoIP).

The Telcom Act of 1996 was a major regulatory change that has also greatly changed aspects of the telephone network. Significantly, it led to the expansion of operating companies to the point where there are now over 11,000 operating companies in the North American Numbering Plan.

The 1996 Act also provided the means for a consumer or business to change operating companies and, within certain location parameters, keep their original 10-digit phone number. Inter-operating company porting of 10-digit phone numbers in conjunction with advances in public use of technology such as mobile phones and other types of public networks such as the Internet have added further complexity.

A company named NeuStar has the responsibility to keep track of all these inter-carrier ported telephone numbers. Today, one can use a network query to the appropriate regional NeuStar NPAC (Number Portability Administration Center) database and identify if a number is ported and the facilities OCN (Operating Company Number) to which the number is ported. Because a single OCN can provide service for multiple line types, one cannot tell with anything close to 100% accuracy whether an OCN is providing POTS, wireless, broadband or another type of network service for a ported number. This issue has been further complicated by many of the hundreds of Internet Service Providers (ISPs) or Internet Access providers (IAPs) starting to provide phone service over the Internet using VoIP technology.

In terms of providing the interface between consumers and businesses and a public network, internet service providers and internet access providers can supply the same functionality as an operating company that is a Local Exchange Carrier (LEC). The consumer or business network address on the Internet is an IP address provided by the ISP/IAP, and a 10-digit phone number is the PSTN network address provided by the LEC or wireless carrier. Due to the emergence of the similar functionality between the technologically different PSTN and IP networks, there are standards such as the ENUM protocol that are being developed to integrate voice calls between the two types of networks.

Initially both the PSTN and the Internet were composed primarily of stationary nodes with very stable network ids in that each node's physical location and its network address remained linked together and constant for long periods of time (e.g., months or years). Mobile devices, however, can of course change location almost continuously, and some mobile IP devices obtain new network ids when they move around from one place to another.

The latest blow to simplicity on the PSTN network was a Federal Communications Commission (“FCC”) decision in the fall of 2003 which required that 10-digit numbers associated with stationary phones could be ported to mobile phones, and vice-versa. Today, there is on the order of 2.15 million numbers ported to a different line type like wire-line to wireless, etc. NeuStar does not currently provide a network query for obtaining this information. For “do not call” compliance requirements, however, NeuStar provides daily updated information for 10-digit numbers ported across network types. There are separate lists for wire-line ported to wireless and wireless ported to wire-line that can be downloaded daily from NeuStar.

In parallel with and addition to the above, there have been several other relevant and significant developments:
(1) The FCC mandated that mobile phone operating companies provide a means to identify the current location of their mobile subscribers for emergency 911 type services. This led to the development and patenting of various location identification technologies based on:
   a. Triangulation by knowing the location of cell towers and the caller's signal strength and/or signal timing difference at each tower;
   b. GPS chips in phones; and
   c. GPS technology assisted by network triangulation, which is commonly called assisted GPS.
(2) In order to keep track of this information the Mobile Operating Companies had to install network nodes commonly called MPCs (Mobile Positioning Centers) to keep track of the current location of the mobile device keyed by its network id. This challenge for mobile carriers is complicated by a subscriber roaming into another carrier's network.
(3) For intra-operating company network commercial customers such as a delivery service, a delivery company's dispatcher can use the MPC-based system to determine the current location of one or more of its delivery people who all have mobile devices associated with the delivery company's OC.
(4) The types of networks expanded greatly with multiple flavors of digital wireless networks: TDMA, CDMA, GSM and PCS to go along with the original analog cellular mobile networks. In addition, voice began being transported over digital packet networks like the Internet and private IP networks in addition to the older POTS wire-line circuit switching networks. Currently the most popular way for transporting of voice over a digital packet network is VoIP.
(5) The interface between the historically primarily POTS PSTN and other networks has made the ANI, which was a highly reliable mechanism in the POTS network for locating network nodes, not nearly as reliable when the call comes from another network type. An example of a current problem is that many small wireless OCs first terminate their wireless customer calls at the OC's platform and then generate a second call to the PSTN network from the platform, thus replacing the caller's true ANI with most commonly a single POTS ANI associated with the platform location. Another version of this type of true ANI corruption is also inherent in some calls being initiated from devices on IP networks using VoIP that then interface with the PSTN to complete the call, where a false ANI is assigned at the interface between the PSTN and IP network.
(6) Technologies exist to integrate Geographic Information System (“GIS”) algorithms such as point-in-polygon and street-by-street driving directions, etc. into real-time, during call or during session determination processes. These GIS-based processes are based on knowing a network node's location in terms of coordinates (e.g., latitude and longitude) and provide a variety of functionality such as determining which nearby service location(s) provides service to a network node's current location.
(7) Voice recognition technology over a network has evolved significantly and it is now quite common to be prompted by an Interactive Voice Response (“IVR”) unit to speak your city-state or 5-digit zip code and then be asked for a street address, intersection or landmark. These spoken words can then be matched to underlying USPS and TIGER files and the location on the earth in terms of a spatial address (e.g., latitude and longitude) corresponding to the spoken information can be determined.
(8) There are now companies such as Digital Envoy that have correlated stationary IP addresses to points on the earth defined by coordinates (again, e.g., latitude and longitude) and other characteristics such as country, state and city. These IP address-to-location correlations for most IP addresses generally are currently geographically coarse and by way of analogy are comparable in precision to the Weber patent's use of NPA.

It is now also possible for one IP device to query a remote GPS-enabled mobile IP device over a wireless network and get the current latitude, longitude and altitude of the mobile device.

Due to the vast variation in age, technology and various equipment types included in or interfacing with the PSTN it is currently not possible to pass something like a caller's current location in terms of a coordinate address such as latitude and longitude to every other network node in the PSTN or to a node connected to the PSTN from another private network or public network such as the Internet.

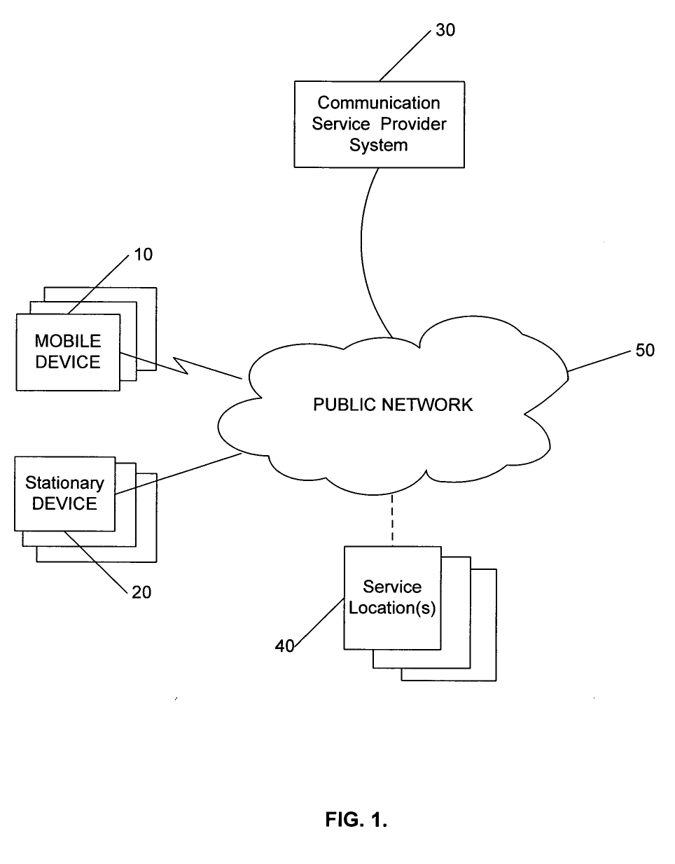

FIG. 1 is a high level block diagram illustrating an example of the network relationship between mobile and stationary devices connected over a public network to communication service providers. In an illustrated embodiment, first party mobile devices 10 and stationary devices 20 (also referred to as nodes or devices) are connected to a service provider system 30 over a public network 50. Though only one network and one service provider system is shown in FIG. 1 for simplicity, the system can contain multiple networks and multiple service provider systems as is described below. Mobile devices 10 are devices designed to maintain network connectivity while moving, such as cellular telephones, PDAs with wireless Internet access, automobiles equipped with network connectivity, etc. Mobile devices 10 can be referred to variously as wireless devices or mobile nodes.

Conversely, stationary devices 20 are devices that generally remain in a fixed location while connected to the network 50, such as POTS telephones and personal computers. Stationary devices 20 can be referred to variously by names such as wire-line devices or stationary nodes. Though both the mobile devices 10 and the stationary devices 20 are depicted as being directly coupled to the public network 50, they can also be coupled to the public network via an intermediary connection such as a private network such as, for example, a cellular telephone system or a cable network system.

There are devices that have aspects of both stationary devices 20 and mobile devices 10. If the location of a device appears static to other nodes on the network, e.g., because the device has a fixed network access point, then notwithstanding that the device has some limited mobility it effectively is a stationary device at this point in time. For example, a 2.4 GHz telephone that communicates through a base unit connected to the PSTN, or a wireless notebook or laptop computer that communicates through a wireless router connected to the Internet/Web, generally are effectively stationary devices 20 because to other nodes on the network such devices appear to be at fixed locations at this point in time.

If a device's variable location can be determined over the network, e.g., provided by the network infrastructure, from the device itself, or reported by a service provider, then such a device effectively is a mobile device 10. For example, if a device includes a GPS receiver and can report its location to the network, such a device effectively is mobile device 10. Similarly, regardless whether the network access point for a wireless laptop or notebook computer remains at a fixed location, if the network infrastructure reports the variable location of the laptop or notebook, then, the device effectively is a mobile device 10. Some devices can meet the requirements of both definitions at a given point in time.

In general, the service provider system 30 can obtain location information to provide value-added services, such as location-based services based on the locations of the network nodes. In some embodiments, the location-based services may include connecting the device to a second party or directing the first party to a second party based on the location information, or selling or offering to sell a product based on the location information. An example of a location-based service is identifying a service location 40 that is nearest to the location of a network node 10 and/or 20, or that has a service area polygon that includes the network node's location. In some cases, the value-added service includes connecting the network node to a selected service location 40, e.g., causing a telephone call to terminate at a telephone number associated with the physical location of the closest store. In some cases a location-based service sends information back to the network node 10 and/or 20 over the network. For example, an interactive voice response (IVR) system can be a part of the service provider 30, can speak back a list of nearby location, or the service provider can transmit information for display such as store attributes, maps, and/or directions.

The value-added services from service providers 30 can be provided in a distributed manner by more than one service provider system that can communicate with one or more device location providers, such as wireless device location providers, wire-line device location providers, location providers for VoIP user, etc. For example, a first service provider can use address information from mobile devices 10 and stationary devices 20 to identify information that it sends over a network to other service providers such as IVR platforms or Internet/Web service platforms. In some cases the information is a location associated with the device 10 and/or 20, e.g., a physical location for the device associated with device address information obtained over the network, or service location information as discussed above. Data transfer between such service provider systems 30 can be over public network 50 (including the public Internet, World Wide Web and/or the telephony SS7 network) or the service providers can exchange data over private links (T-1, frame relay, etc.).

Location-based services that identify a location of a consumer-initiated telephone call are one type of value-added service. As disclosed in the Moore and Shaffer patents (U.S. Pat. Nos. 5,506,897, 5,901,214, and 5,982,868, all of which are hereby incorporated by reference) it is known to provide such location-based services through use of the ANI feature from the telephone network or by prompting the caller to provide address information.

In one embodiment, the service provider system (“service provider”) 30 is a computer system which includes a location-based service module and a location determination module. In one embodiment, a service provider is implemented as one or more computer servers or computer systems and associated storage systems with data bases connected to the network 50. The location determination module can obtain information about the location of a device. The location based service module responds to requests for location-based services. It also obtains the location information pertaining to the device that transmitted the request. In one embodiment the location determination module provides the location information to the location-based service module. Alternatively, the location-based services module or the location determination module can send a request for location information to a second service provider.

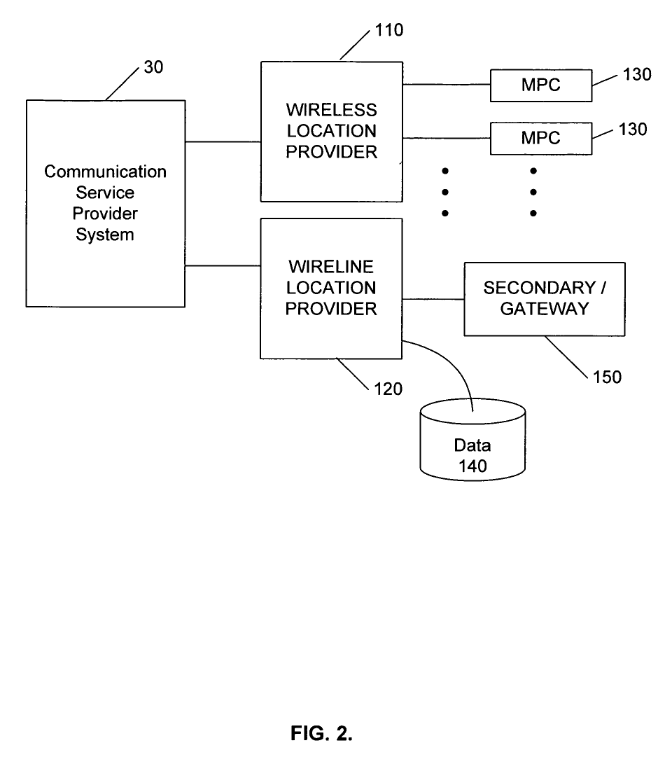

FIG. 2 is a high level block diagram illustrating an example of interfaces to wire-line and wireless location providers, and a communication service provider 30. If the service provider 30 is attempting to obtain the location of a mobile device 10, then, it queries a wireless location provider 110, which in turn can obtain the location of the mobile device 10 from, e.g., a MPC 130 and then provide that information to the service provider 30. If the service provider 30 is attempting to obtain the location of a stationary device 20, then, it queries a wire-line location provider 120, which in turn either retrieves the location from a database system 140 or obtains the location from a secondary source, via a gateway 150. Note the databases described herein can be implemented as and are intended to encompass tables, files and relational databases. Therefore, references to different databases encompass different tables or files in the same database structure or storage system and relational databases including the same information described as being in the different databases.

While FIG. 2 shows separate wire-line and wireless location providers 110, 120, in an alternative embodiment the functionality of either or both location providers is embedded in service provider 30. Similarly, there are alternatives to the interposition shown in FIG. 2 of wireless location provider 110 between service provider 30 and MPCs 130 and the interposition of wire-line location provider 120 between service provider 30 and database system 140, and gateway 150. Alternatives include providing for direct access by service provider 30 to any or all of MPCs 130, database system 140, and gateway 150 based on information obtained from location providers 110, 120.

The Moore and Shaffer patents mentioned above describe exemplary systems and methods for database 140 of wire-line location information. For PSTN telephony addresses that typically are a ten-digit telephone number, the telephone number is translated to a spatial key or index such as a ZIP+4 code. The spatial key or index then is used to retrieve a latitude and longitude pair, for example using a file obtained from GDT. For addresses not found in database 140 or for address information from database 140 that might be stale or for which there is uncertainty, wire-line location provider 120 can query another provider via gateway 150 to obtain information, such as databases from OCs (LIDBs) or other third-party data providers.

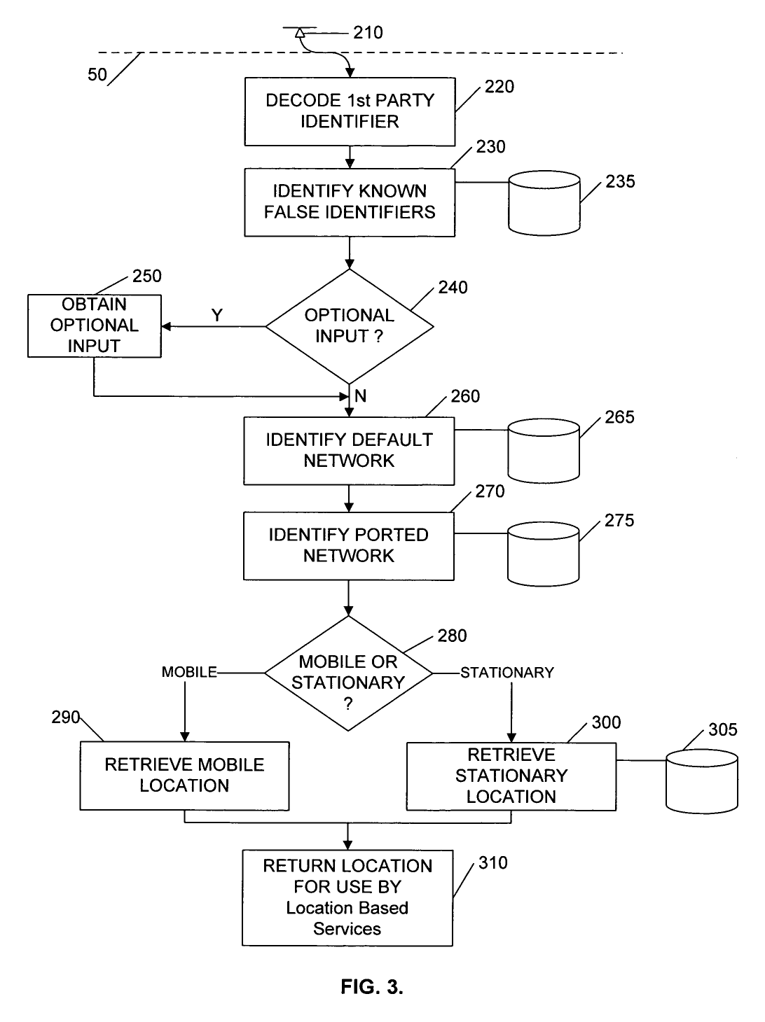

FIG. 3 is a flowchart illustrating an exemplary process for the determination of the source of location information during communication with a wire-line or wireless device. In one embodiment, this process is implemented by the location determination module and the location-based service module of the service provider.

At a step 210, a first party uses a device to request a location based service or initiate a transaction over network 50, such as a telephone call (e.g., PSTN, cellular, VoIP) or a wireless Internet/Web transaction. At a step 220, the service provider obtains and decodes an address or identifier of the first party. The identifier may indicate, for example, either a telephone call or an Internet transaction. For a telephone call transaction the identifier typically is a telephone number, such as an obtained ANI or number provided by the caller via DTMF or speech input, although other identifiers such as street addresses or intersections are possible. Other network transactions can have other network addresses, such as an IP address for a wireless Internet transaction from a PDA or for a VoIP telephony transaction.

At a step 230, the service provider identifies problems or issues with the identifier obtained at step 220 using database 235 in order to obtain either a new identifier or further process the identifier. One problem that can occur is when a mobile network or VoIP network service provider causes all transactions from that network to be associated with a single identifier. For example, all telephone calls from some wireless network providers can appear to originate from the same telephone number because the wireless network provider assigned the identifier at the point of access to the PSTN network. Similarly, the original identifier of a first party initiating a transaction over a VoIP network can be substituted by a different or false identifier by the network provider at the point of interface to the PSTN network. Database 235 contains information to identify these types of problems or issues.

In lieu of or in addition to database 235, service provider 30 can query third party systems and/or databases to identify false or problem identifiers. Known false or problem identifiers can be identified in various ways. For example, an abnormally high volume of transactions from a single phone number or other network identifier can indicate the occurrence of all transactions being assigned the identifier of the PSTN network access point. This can be determined by the service provider 30 (or a third party) keeping counts, such as keeping a count of transaction by identifier. In this case the phone number in question can be investigated by accessing network databases such as LIDB, LNP, and CNAM to determine the nature of the entity that owns the number.

If an identifier is associated with a location for which there is no data, such as an overseas call, the service provider 30 can either obtain a new identifier (e.g., by prompting a telephone caller via an Interactive Voice Response (“IVR”) system or through a GUI for a wireless Internet device) or choose to terminate the transaction processing as appropriate.

New identifiers can be obtained in various ways, such as through optional input as discussed below. Other examples are handwriting recognition (such as can be provided on a PDA) or speech recognition (such as can be done by an IVR for a mobile phone) of an identifier such as an address. Other methods of obtaining an identifier supported by the device and the network are contemplated.

At a decision point 240 the system determines whether there is a need or desire for optional input and, if so, then, at a step 250 the system obtains the input. Some applications allow optional input for identifying information that correlates to a location, such as, for example, a street address, intersection, or telephone number. The optional information may be required either because it was not possible to obtain an identifier from the network, or because step 230 determined that the obtained identifier was false or problematic. Alternatively, the optional information may be simply required to allow replacement of the obtained identifier (e.g., to replace a questionable identifier or to provide a replacement (e.g. an alternative) identifier for use in a location-based service). In an exemplary telephone call application, if the obtained ANI is known to be false or invalid, then the application prompts the caller to provide a new telephone number, either by speech or DTMF input.

At a step 260 the service provider 30 uses a database 265 and the identifier obtained from either step 220 or 250 to identify the type of network associated with the identifier. In lieu of or in addition to the database 265, service provider 30 can query third party systems and/or databases as necessary to identify the default network type. For example, for a telephone call transaction where the obtained identifier is the caller's ANI, the TPM file from Telcordia can identify the default type of network as well as the OC assigned to a number. However, as discussed above, for telephone numbers it is possible that the number has been ported between wire-line and wireless devices, and it also is possible that a particular OC can provide both wire-line and wireless network service for any given subscriber. Thus, further processing as described below can be necessary.

At a step 270 the service provider 30 determines whether to use the default network type from the step 260 or whether the identifier has been ported to a different network type via database 275. Once again, as with databases 235 and 265, in lieu of, or in addition to database 275, service provider 30 can query third party systems and/or databases as necessary to determine whether the identifier has been ported to a different type of network service provider. For telephone numbers a query to the NeuStar NPAC database will identify whether a number has been ported and, if so, to which Operating Carriers (“OC”). In order to determine the default network type, however, it is necessary to use the daily updated files from NeuStar that identify numbers ported from wire-line to wireless and from wireless to wire-line providers.

At a decision point 280, the service provider 30 uses the network type and OC identified in the steps 260, 270 to identify whether the first party 210 is communicating using a mobile device 10 or stationary device 20. In the case of a mobile device, in a step 290, the service provider 30 makes an appropriate query either to the mobile device or to the mobile network infrastructure to obtain location information. In the case of a stationary device 20, at a step 300, the service provider 30 makes an appropriate query to a database 305 to retrieve location information. Once again, consistent with variations for databases 235, 265, and 275 above, third-party databases and systems can provide the information obtained from database 305.

Finally, at a step 310, the service provider 30 provides the retrieved location information for use in various types of location-based applications.

In one embodiment the first party identifier obtained in step 220 by a first service provider (such as a Wireless Location Provider 110 or a Wireline Location Provider 120) is then transmitted to a second service provider that performs steps 230 through 310. The second service provider then provides the location for use in one or more of the various types of location-based applications described herein.

As discussed above, telephone numbers and IP addresses are exemplary identifiers, part or all of which can provide information for determining the type of network (e.g., mobile or stationary) and the particular network service provider for a device 10 or 20. The service provider can also translate identifiers, such as through a database system or translation table that correlates 10-digit telephone numbers to IP addresses, in order to obtain useful network information. One example is a wireless phone that includes a GPS receiver and that can provide latitude and longitude of the device in response to a network query, such as over the wireless Internet. In this case a translation table of telephone numbers correlated to IP addresses allows the telephone number to be used to identify the IP address to query for the location as part of step 290. Implementation of the ENUM protocols related to convergence of telephone and Internet devices will further facilitate the ability to decode or translate identifiers as necessary to obtain location information.

There can be many variations to the foregoing examples of methods for obtaining location information of mobile and/or stationary devices 10, 20 in steps 290, 300 based on an identifier such as an IP address. For mobile devices 10 that can provide location information such as from a GPS receiver, in lieu of an IP query it is possible to query such devices via the packet-switched data network used by the wireless telephony infrastructure. Also, companies such as Digital Envoy provide a mechanism for determining a geographic location of an IP address, so at the step 300 the system can query information provided by such a company. Further, as discussed in U.S. Pat. No. 6,748,426 entitled System and Method for Linking Information in a Global Computer Network, it is possible to retrieve data stored on a device, such as in an Internet cookie, to obtain device location information.

Similarly, Internet “hot spots”, which generally provide wireless Internet and Web access for mobile devices, can provide location information for devices currently connected through the hot spots. Interestingly, the hot spot itself can be mobile. For example, Internet Service can be provided by an airplane, in which case, the ISP and all devices connected to it can move at hundreds of miles per hour. This example also highlights the issue of altitude, which may be useful in identifying locations that can provide service to a mobile device 10. If a device is traveling in an airplane, altitude effectively would rule out “nearby” locations that might happen to have the same latitude and longitude. A more practical example is a mobile device in a multi-story shopping center or a high rise building, in which case altitude can be used to identify the nearest or most appropriate service location as a location other than that which latitude and longitude alone would identify as “closest” or “best.”

Typically, the final step in a location-based service to an individual user is the actual provision of a service based on the party's location. An example is a “finder” location, such as an ATM finder that speaks back information (e.g., the nearest location or a list of nearby locations) or provides the information for display on a PDA or other device. As discussed in prior art such as Shaffer, services can include linking to other data in order to provide other diverse and valuable services, such as maps and driving directions. There is significant value in an effective means for providing location information for many businesses because of the ephemeral nature of a sales opportunity—failure to provide correct information to someone using a mobile phone or PDA who seeks the location of the nearest Starbucks has a high likelihood of qualifying as a lost sale.

Service providers that implement methods for determining device location information for use in location-based services can do so in a variety of configurations. While a single service provider 30 can implement all aspects of a process for providing a location-based service, for various business and technical reasons it can be useful to divide functionality across multiple providers, such as by having one service provider 30 act as a broker or gateway for requests from other service providers for mobile device 10 locations, with a different service provider 30 for requests for stationary device 20 locations. There can be further subdivision, such as with different service providers 30 for different types of stationary devices 20, e.g., a service provider for telephones, a service provider for IP devices, etc., with these providers further comprising multiple providers. For example, if a national telephone device location provider does not have a device location it can query another provider, such as the local exchange provider for that device.

Similarly, there can be diverse allocation of functionality of the various methods described above. For example, a first service provider 30 such as an IVR platform or Web service provider can handle obtaining a first party identifier of a device 10 or 20. Then, the first service provider 30 can interface with a second service provider 30 which implements the steps necessary to identify a location for the first party device 10 or 20 (and also interfacing with other providers as needed to obtain the location). The second service provider 30 can then provide the location-based service for the first party or it can provide the location back to the first provider 30, or to a servicing location 40, or to a third service provider 30.

Those of skill will further appreciate that the various illustrative logical blocks, modules, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, or step is for ease of description. Specific functions or steps can be moved from one module, block or without departing from the invention.

The above description of the disclosed embodiments is provided to enable any person skilled in the art to make or use the invention. Various modifications to these embodiments will be readily apparent to those skilled in the art, and the generic principles defined herein can be applied to other embodiments without departing from the spirit or scope of the invention. Thus, the invention is not intended to be limited to the embodiments shown herein but is to be accorded the widest scope consistent with the principles and novel features disclosed herein.

1. A communication service provider system determining device location in heterogeneous network for location-based services provided over a network, the system comprising:
a communication service provider system configured to obtain a first party identifier associated with a first party device during communication over a network,
determine a network type and a network identifier from a plurality of network types and network identifiers based on the obtained first party identifier,
select a device location provider from a plurality of device location providers based on the network type and the network identifier,
obtain location information from the selected device location provider based on the obtained identifier, and
provide the location information for use in a location-based service.

2. The system of claim 1, further comprising a first device location provider coupled to communication with the network and configured to obtain the location information by retrieving that information from own database.

3. The system of claim 2, wherein the communication service provider system includes the first device location provider.

4. The system of claim 2, wherein the first device location provider communicates with the communication service provider over the network.

5. The system of claim 2, wherein the device location provider obtains the location information by transmitting a query to another location provider.

6. The system of claim 2, wherein the device location provider obtains the location information by retrieving that information from a Mobile Positioning Center.

7. The system of claim 2, wherein the device location provider obtains the location information by retrieving that information from secondary providers via gateways.

8. The system of claim 2, wherein the device location provider obtains the location information by retrieving that information from location providers for VoIP users.

9. The system of claim 2, wherein the device location provider is a wireless location provider.

10. The system of claim 2, wherein the device location provider is a wire-line location provider.

11. A computer implemented communication system for location-based services for use over a network with a plurality of device location providers for providing location information for mobile and stationary devices, the system comprising:
a communication service provider system configured to (a) obtain a first party identifier associated with a first party device during communication by a first party over a network, (b) determine a network type and a network identifier based on the obtained first party identifier, (c) select a device location provider based on the network type and the network identifier, and (d) obtain location information from the selected device location provider based on the obtained identifier;
a wireless location provider configured to provide location information associated with the first party device to the communication service provider if the first party device is a mobile communication device; and
a wire-line location provider configured to provide location information associated with the first party device to the communication service provider if the first party device is a stationary communication device.

12. The system of claim 11, wherein the wireless location provider obtains the location information by retrieving that information from a Mobile Positioning Center.

13. The system of claim 11, wherein the wire-line location provider obtains the location information by retrieving that information from its own database.

14. The system of claim 11, wherein the wire-line location provider obtains the location information by retrieving that information from a secondary provider via a gateway.

15. The system of claim 11, further comprising a location provider for VoIP users configured to provide location information associated with the first party device to the communication service provider if the first party device is a VoIP user.

16. A method for providing network location information for location-based services for parties communicating over networks from multiple carriers, the method comprising:
obtaining an identifier associated with a first party device during communication over a network;
determining a network type and a network identifier from a plurality of network types and network identifiers based on the obtained first party identifier;
selecting a device location provider based on the network type and the network identifier;
obtaining location information from the selected device location provider based on the obtained identifier; and
providing the location information for use in a location-based service.

17. The method of claim 16, wherein the obtained first party identifier device is the ANI of a telephone call.

18. The method of claim 16, wherein the obtained first party identifier is an IP address.

19. The method of claim 16, wherein the obtained first party identifier is provided by the network.

20. The method of claim 16, wherein the obtained first party identifier is provided by the first party device.

21. The method of claim 16, wherein the plurality of network types includes wire-line and wireless telephony networks.

22. The method of claim 16, wherein the plurality of network types includes an IP network.

23. The method of claim 22, wherein the plurality of network types includes one or both of wireless Internet and VoIP networks.

24. The method of claim 16, wherein the plurality of network identifiers includes Operating Carrier identifiers.

25. The method of claim 16, wherein determining the network identifier is based at least in part on use of the ENUM protocol.

26. The method of claim 16, wherein selecting a device location provider comprises selecting a first service for a wire-line network type and a second service for a wireless network type.

27. The method of claim 16, wherein the first party device is a wireless network device and obtaining location information comprises querying a service that provides location obtained from the wireless network infrastructure.

28. The method of claim 16, wherein obtaining location information comprises obtaining the location information provided from a first party device that includes a GPS receiver.

29. The method of claim 16, wherein obtaining location information comprises indexing a database with a telephone number.

30. The method of claim 16, wherein obtaining location information comprises obtaining altitude information.

31. The method of claim 16, wherein obtaining location information comprises routing a location information request to one of a plurality of device location providers based on device location provider service availability information.

32. The method of claim 16, wherein obtaining location information comprises obtaining location information of a network access point of the first party device.

33. The method of claim 16, wherein obtaining location information comprises obtaining location information from a network access point of the first party device.

34. The method of claim 16, wherein obtaining location information comprises sending a query over a network to obtain a location of a telephone number.

35. The method of claim 16, wherein obtaining location information comprises sending a query over a network to obtain a location of an IP address.

36. The method of claim 16, wherein obtaining location information comprises sending a query to obtain a location provided from the first party device.

37. The method of claim 16, further comprising connecting the first party device to a second party based on the location information.

38. The method of claim 16, further comprising directing the first party to a second party based on the location information.

39. The method of claim 16, further comprising offering to sell a product based on the location information.

40. The method of claim 16, further comprising selling a product based on the location information.

41. A method of providing location information for mobile and stationary communication devices, the method comprising:
obtaining an identifier associated with a first party device during communication over a network;
obtaining a default network identification from a first database based on the obtained identifier;
determining if the default network identification is valid or invalid based on a third party data source;
if the default network identification is invalid then obtaining a replacement network identification from a second database based on the obtained identifier;
determining if the first party device is a mobile device or a stationary device based on the network identification;
obtaining the first party device location from a stationary device location provider if the first party device is a stationary device or from a mobile device location provider if the first party device is a mobile device; and
providing the location for use in a location-based service.

42. The method of claim 41, wherein the obtained identifier is the ANI of a telephone call.

43. The method of claim 41, wherein the obtained identifier is an IP address.

44. The method of claim 41, wherein the obtained identifier is automatically provided by the network.

45. The method of claim 41, wherein the obtained identifier is provided by the first party device.

46. The method of claim 41, wherein the default network is determined to be either a wire-line or wireless network.

47. The method of claim 41, wherein obtaining the default network identification comprises identifying the default network based on a subset of the obtained identifier.

48. The method of claim 47, wherein the subset of the obtained identifier includes the area code and exchange of a telephone number.

49. The method of claim 41, wherein determining if the default network identification is valid or invalid comprises retrieving information on identifiers that have been ported between wire-line and wireless networks.

50. The method of claim 41, further comprising connecting the first party device to a second party based on the location information.

51. The method of claim 41, further comprising directing the first party to a second party based on the location information.

52. The method of claim 41, further comprising offering to sell a product based on the location information.

53. The method of claim 41, further comprising selling a product based on the location information.

54. A method of providing network location information for location-based services for mobile and stationary communication devices, the method comprising:
obtaining an identifier associated with a first party device during communication over a network;
determining if the first party device is a mobile device or a stationary device based on the obtained first party identifier;
if the first party device is determined to be a mobile device then
(a) identifying a network provider based on the obtained identifier; and
(b) obtaining location information from a mobile device location provider based on the network provider and the obtained identifier;
if the first party device is determined to be a stationary device then obtaining location information from a stationary device location provider based on the obtained identifier; and
providing the location information for use in a location-based service.

55. The method of claim 54, wherein determining if the first party device is a mobile device or a stationary device includes:
identifying a default device type of mobile or stationary from a first database based on the obtained first party identifier; and
determining whether to use the default device type based on information from a second database based on the obtained first party identifier.
